(19) United States
(12) Patent Application Publication
(10) Pub. No.: US 2004/0047611 A1
(43) Pub. Date: Mar. 11, 2004

(54) Optical disc apparatus

(75) Inventor: Kazuki Hayashibara, Osaka (JP)

Correspondence Address: CROWELL & MORING LLP, INTELLECTUAL PROPERTY GROUP, P.O. BOX 14300, WASHINGTON, DC, 20044-4300, US

(73) Assignee: Funai Electric Co., Ltd.

(21) Appl. No.: 10/656,197

(22) Filed: Sep. 8, 2003

(30) Foreign Application Priority Data
Sep. 6, 2002 (JP) 2002-261134

(51) Int. Cl. H04N 5/781

(52) U.S. Cl. 386/96; 386/126

(57) ABSTRACT

In an optical disc apparatus using a decoder chip with no synchronization function of audio data and visual data, when reproduction of the audio data is not synchronized with reproduction of the visual data, the reproduction of the audio data is paused or fast-forwarded in a predetermined period for shortening the delay between the audio data and the visual data in a term during which no sound is outputted, for example, when operation mode of the optical disc apparatus is switched from fast-forwarding mode to reproducing mode or from pausing mode to reproducing mode.

### BACKGROUND OF THE INVENTION

1. Field of the Invention

The present invention relates to an optical disc apparatus for reading video data from an optical disc such as a DVD (Digital Versatile Disc), and reproducing the video data as a moving picture on a monitor display apparatus.

2. Description of the Related Art

For recording the video data such as a moving picture taken by a video camera or a moving picture of a TV program received by a TV tuner on an optical disc such as the DVD, the video data are conventionally encoded in compliance with MPEG (Moving Picture Experts Group) standard. Similarly, for reproducing the video data recorded on the optical disc, the encoded video data are read out from the optical disc and decoded in compliance with the MPEG standard.

While the video data are read out from the optical disc, visual data are decoded in compliance with MPEG2 standard, and audio data are decoded incompliance with MP3 standard. Since the visual data and the audio data are independently decoded by different decoding circuits or decoder chips, it is necessary to output the audio data in synchronism with the visual data corresponding to predetermined AV (Audio/Visual) synchronization signals (this process is called “AV synchronization process”) for reproducing the moving picture on a screen of the monitor display apparatus.

FIG. 4 illustrates a configuration of a conventional apparatus shown in publication gazette of Japanese patent application 8-322043. Such the conventional apparatus inherently relates to a frame rate converter for converting frame rate of a moving picture. For example, when a video code recorded in a frame rate of 25 frames/sec is displayed in a frame rate of 30 frames/sec, video code data for one picture are repeated per five pictures so that six pictures are displayed in the same period as five pictures. Alternatively, when a video code recorded in the frame rate of 30 frames/sec is displayed in the frame rate of 25 frames/sec, video code data for one picture per six pictures are skipped without being decoded so that five pictures are displayed in the same period as six pictures.

In the conventional apparatus illustrated in FIG. 4, an AV synchronization controller 101 controls for synchronizing reproduction of the audio data with reproduction of the visual data. A frame rate converting controller 102 outputs alternative of a picture repeat request signal RP and a picture skip request signal RS corresponding to feeding of a decoding timing signal TD. A video timing generator 103 generates a display timing signal TH and the decoding timing signal TD corresponding to feeding of a video synchronization signal SY. A decoding controller 104 outputs a decoding start signal DS corresponding to feeding of the decoding timing signal TD. A video code buffer 105 temporarily stores video code data DV and serially feeds the video code data DV to a picture decoder 106. The picture decoder 106 decodes the video code data DV for one picture corresponding to feeding of the decode start signal DS and skips the video code data DV for one picture without decoding corresponding to feeding of the skip request signal RS.

The frame rate converting controller 102 includes a check signal generator 108 for generating a synchronization check timing signal TC, which shows the inherent decoding timing with no frame conversion, corresponding to feeding of a system clock SC. The AV synchronization controller 101 includes a check circuit 107 for checking the AV synchronization corresponding to feeding of a synchronization check timing signal TC. By such a configuration, the AV synchronization process can be executed with no relation to the frame rate conversion.

On the other hand, publication gazette of Japanese patent application 10-262208 shows a conventional AV synchronization controller which stops the decoding of the visual data in one picture unit when the reproduction of the visual data goes ahead of the reproduction of the audio data, and skips the decoding of the visual data for a predetermined period when the reproduction of the visual data is delayed from the reproduction of the audio data.

In the conventional optical disc apparatus, AV synchronization processing function such as the AV synchronization controller 101, the check circuit 107 and the check signal generator 108 are accomplished by hardware, so that the AV synchronization function is built in a chip with decoding function. For building the AV synchronization function in the decoder chip, it is necessary to increase a capacity of a memory of the decoder chip so as to memorize the visual data and the audio data for a predetermined time duration.

In recent years, corresponding to speeding up of working speed of a CPU (Central Processing Unit), the function, which is conventionally accomplished by hardware, can be accomplished by software, so that hardware of an apparatus tends to be simplified and made at a low-cost. Accordingly, for manufacturing the optical disc apparatus at a low-cost, a decoder chip with no AV synchronization function has been practically used.

When the audio data are recorded in the same time period as the visual data, the reproduction of sounds corresponds with the reproduction of moving picture, even though the video data are reproduced with no AV synchronization check in an optical disc apparatus using a decoder chip having no AV synchronization processing function. Discrepancy between the sound and the moving picture, which is called “lip sync”, can occur not only due to an audio gap in which no audio data is recorded with respect to the visual data, but also due to reading error of the video data caused by scratch or dust on the surface of the optical disc. The lip sync occurs not only due to the reproduction of the audio data going ahead of the reproduction of the visual data, but also the reproduction of the visual data going ahead of the reproduction of the audio data.

Furthermore, in the conventional apparatus shown in the publication gazette 10-262208, since the timing for decoding the visual data is controlled for synchronizing the reproduction of the visual data with the reproduction of the audio data, a buffer memory for memorizing the visual data of a predetermined number of pictures (frames). Capacity of the visual data, however, is very large, so that it is necessary to increase the capacity of the buffer memory much larger for synchronizing the reproduction of the visual data with the reproduction of the audio data. The increase of the capacity of the buffer memory causes the cost up.

### SUMMARY OF THE INVENTION

An object of the present invention is to solve the above-mentioned problems and to provide an optical disc apparatus using a decoder chip having no AV synchronization processing function, in which the lip sync between the visual data and the audio data can be compensated without increasing the capacity of the buffer memory for memorizing the visual data.

An optical disc apparatus using a decoder chip with no synchronization processing function of audio data and visual data in accordance with an aspect of the present invention comprises: an optical pickup device for reading video data from on optical disc; a separator for separating visual data and audio data from the video data; a visual data decoder for decoding the separated visual data; an audio data decoder for decoding the separated audio data; a time information extractor independently for extracting time information of visual data from the visual data and for extracting time information of audio data from the audio data; a lip sync judger for comparing the time information of the visual data with the time information of the audio data at a predetermined interval, and judges whether reproduction of the audio data is synchronized with reproduction of the visual data or not; and a lip sync compensator for compensating lip sync between the audio data and the visual data by pausing or fast-forwarding the reproduction of the audio data in a predetermined period while no sound is outputted.

By such a configuration, when the reproduction of the visual data is not synchronized with the reproduction of the audio data, the reproduction of the audio data is compensated while no sound is outputted, for example, when a driving mode of the optical disc apparatus is switched from fast-forwarding mode to reproducing mode or from pausing mode to reproducing mode. Specifically, when the reproduction of the audio data goes ahead of the reproduction of the visual data, the reproduction of the audio data is paused in the predetermined period. Alternatively, when the reproduction of the audio data is delayed from the reproduction of the visual data, the reproduction of the audio data is fast-forwarded by the predetermined period. Accordingly, the lip sync between the visual data and the audio data can be compensated with giving unpleasant feeling to a TV viewer.

Furthermore, when the reproduction of the audio data is paused or fast-forwarded in the predetermined period, it is possible to memorize the audio data for the predetermined term in an audio data buffer (firmware) which is used in normal reproduction mode, so that the capacity of the buffer memory of the decoder chip is not necessarily increased. Since the lip sync compensation of the reproduction of the audio data with respect to the reproduction of the visual data can be processed by stopping the output of the audio data or discarding the audio data of the predetermined period. No particular software for AV synchronization process is necessary.

### BRIEF DESCRIPTION OF THE DRAWINGS

FIG. 1 is a block diagram showing a constitution of an optical disc apparatus in accordance with an embodiment of the present invention;

FIG. 2 is a block diagram showing a configuration of a decoder in the optical disc apparatus in the embodiment;

FIG. 3 is a flowchart showing a lip sync compensation process (AV synchronization process) in the embodiment; and

FIG. 4 is a block diagram showing a configuration of a conventional frame rate converter.

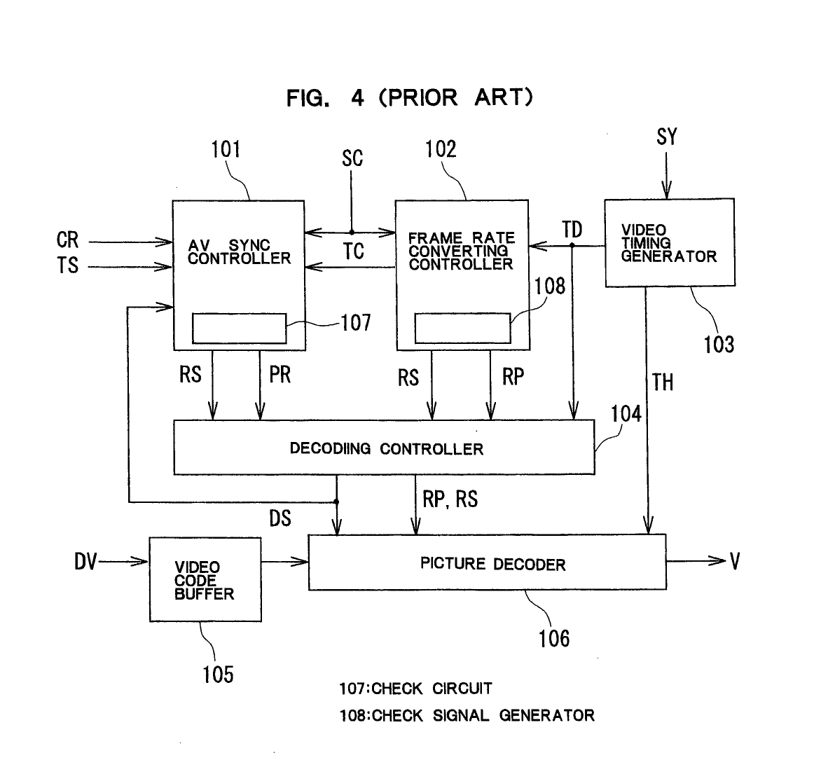

### DETAILED DESCRIPTION OF THE EMBODIMENT

An embodiment of an optical disc apparatus in accordance with the present invention is described. The optical disc apparatus uses a decoder chip having no AV synchronization processing function. When reproduction of visual data are not synchronized with reproduction of audio data, reproduction of the audio data is paused or fast-forwarded in a predetermined term during which no sound is outputted so that the lip sync between the visual data and the audio data can be compensated without giving unpleasant feeling to a TV viewer.

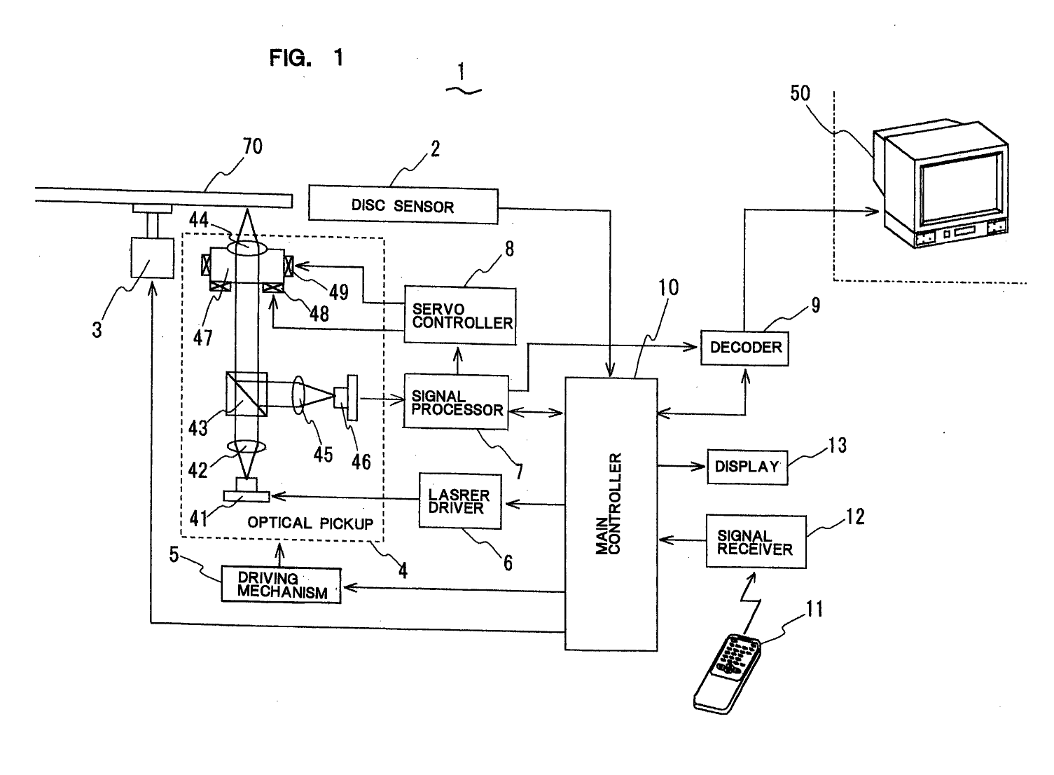

FIG. 1 shows an electric block configuration of the optical disc apparatus in the embodiment. The optical disc apparatus 1 comprises a disc sensor 2, a spindle motor 3, an optical pickup 4, a driving mechanism 5, a laser driver 6, a signal processor 7, a servo controller 8, a decoder 9, a main processor 10, a remote controller 11, a signal receiver 12 and a display device 13. The servo controller 8 serves as not only a focusing servo controller but also a tracking servo controller.

The main processor 10 constituted by, for example, a ROM for memorizing an operation program, a CPU for executing the operation program, and a RAM temporality for memorizing data to be processed.

The disc sensor 2 senses whether an optical disc 70 is loaded on a tray (not shown) or not and outputs a sensing signal corresponding to the existence or nonexistence of the optical disc 70 to the main processor 20. When the optical disc 70 is loaded on the tray, the optical disc 70 will be chucked on a rotation shaft of the spindle motor 3 so as to be rotated. The rotation of the spindle motor 3 is controlled under the main processor 10.

When the video data are reproduced from the optical disc 70, the optical pickup 4 emits a laser light beam on the optical disc 70, receives a reflected light from the optical disc 70, converts the reflected light to electric signals and outputs the electric signals of video data to the decoder 9. When data are recorded on the optical disc 70, the optical pickup 4 emits light beams pulsatively on the optical disc 70 correspondingly to the contents of the data to be recorded. The optical pickup 4 is moved in a radial direction of the optical disc 70 by the driving mechanism 5, which is constituted by, for example, a linier motor. The movement of the driving mechanism 5 is controlled under the main processor 10. The decoder 9 extracts visual data and audio data from the video data, decodes the visual data in compliance with the MPEG2 standard and decodes the audio data in compliance with the MP3 standard. The decoded visual data and the audio data are outputted to the monitor display apparatus 50, so that a moving picture is reproduced on the screen of the monitor display apparatus 50. Details of the decoder 9 will be described below.

The optical disc 4 comprises a laser diode 41 for emitting laser light beams, a collimator lens 42 for expanding the light beams emitted from the laser diode 41, a beam splitter 43 for transmitting and reflecting the light beams corresponding to incident direction of the light beams and an objective lens 44 for focusing each light beam on the optical disc 70. The light beam focused on the optical disc 70 is reflected on the data recording face of the optical disc 70. The reflected light is received by a photo-sensor 46 through the objective lens 44, the beam splitter 43 and a condenser lens 45.

The emission of the light beam by the laser diode 41 is controlled by the laser driver 6 under the control of the main processor 10. The photo-sensor 46 is constituted by a photodiodes in which a photo-sensing face is divided into a plurality of areas and each area outputs electric signals corresponding to variation of intensity of received light. Output signals from the photo-sensor 46 are inputted to the signal processor 7.

The objective lens 44 is held on a lens holder 47. A focusing coil 48 and a tracking coil 49 are provided on the lens holder 47. The focusing coil 48 minutely moves or displaces the objective lens 44 on the lens holder 47 in a direction perpendicular to the data recording face of the optical disc 70 by electromagnetic action with a magnet (not shown). The tracking coil 49 minutely moves or displaces the objective lens 44 on the lens holder 47 in a direction parallel to the data recording face of the optical disc 70, similarly to the focusing coil 48.

The signal processor 7 generates RF signals corresponding to the data recorded on the optical disc 70, focusing error signals and tracking error signals based on the output signals from the photo-sensor 46. The RF signals are outputted to the decoder 9, and the focusing error signals and the tracking error signals are outputted to the servo controller 8.

Each focusing error signal corresponds to a quantity of displacement of the concentration point of the light beam focused by the objective lens 44 from the data recording face of the optical disc 70. Each tracking error signal corresponds to a quantity of displacement of the concentration point of the light beam from a data recording track on the optical disc 70. The servo controller 8 controls the current supply to the focusing coil 48 and the tracking coil 49 for moving the objective lens 44 on the lens holder 47 based on the focusing error signals and the tracking error signals. Thus, the concentration point of the light beam can be placed on the data recording track and on the data recording face of the optical disc 70.

The remote controller 11 has a plurality of operation keys, which is operated by a user (TV viewer) for selecting a function among several operations of the optical disc apparatus 1. The remote controller 11 transmits infrared ray signals corresponding to the selection by the user. The signal receiver 12 receives the infrared ray signals from the remote controller 11, and outputs operation signals corresponding to the infrared ray signals to the main processor 10. The display device 13 is provided on a front panel of a housing of the optical disc apparatus 1, and displays the contents of the operations selected by the user through the remote controller 11, an operative condition of the optical disc apparatus 1, and so on.

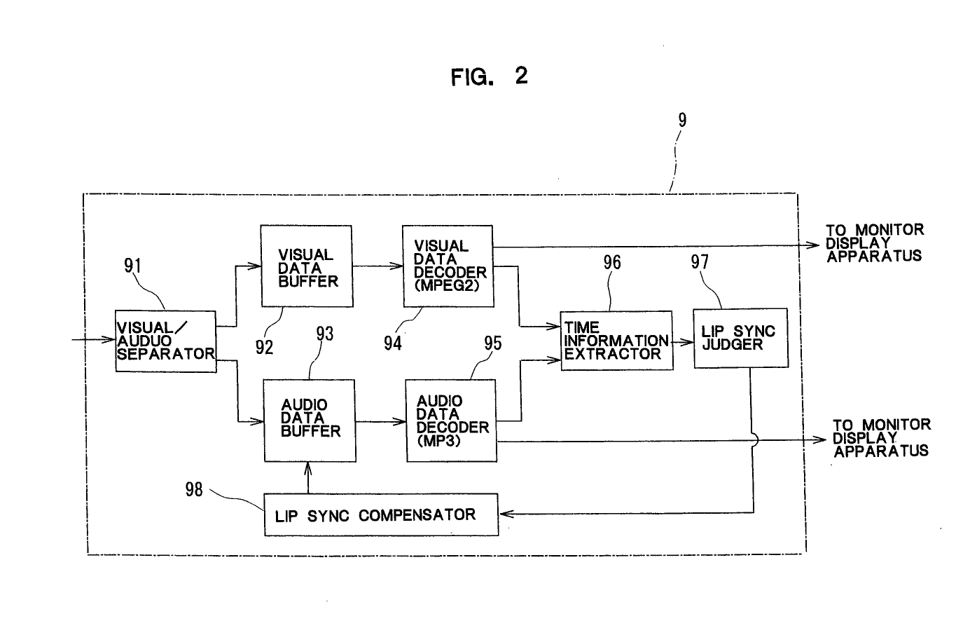

Subsequently, a block diagram of the decoder 9 in this embodiment is illustrated in FIG. 2. The decoder 9 comprises a visual/audio separator 91, a visual data buffer 92, an audio data buffer 93, a visual data decoder 94, an audio data recorder 95, a time information extractor 96, a lip sync judger 97 and a lip sync compensator 98.

The visual/audio separator 91 separates the audio data and the visual data from the RF signals outputted from the signal processor 7. The visual data buffer 92 temporarily stores the separated visual data. The audio data buffer 93 temporarily stores the separated audio data. The visual data decoder 94 serially decodes the visual data for one picture (one frame) by one, which is serially outputted from the visual data buffer 92, in compliance with the MPEG2 standard. The audio data decoder 95 decodes the audio data outputted from the audio data buffer 93 in compliance with the MP3 standard. The time information extractor 96 extracts time information at the moment with respect to the visual data and the audio data, which are reproduced at the moment, from the decoded visual data and the decoded audio data. The lip sync judger 97 compares the time information of the visual data with the time information of the audio data, and judges whether the reproduction of the audio data is synchronized with the reproduction of the visual data or not. When the reproduction of the audio data is not synchronized with the reproduction of the visual data, the lip sync judger 97 further judges either of the reproduction of the audio data and the reproduction of the visual data goes ahead. Furthermore, the lip sync judger 97 measures a delay between the audio data and the visual data. The lip sync compensator 98 compensates the lip sync under a predetermined condition, when the lip sync occurs between the audio data and the visual data.

Since the visual data decoder 94 and the audio data decoder 95 are constituted by, for example, MPEG decoder chips having no AV synchronization processing function, the lip sync between the audio data and the visual data is compensated by firmware process owing to the lip sync compensator 98, when the reproduction of the audio data is not synchronized with the reproduction of the visual data.

Subsequently, the compensation of the lip sync between the audio data and the visual data is described. The lip sync between the audio data and the visual data occurs not only due to the above-mentioned audio gap in which no audio data is recorded with respect to the visual data, but also due to reading error of the video data caused by scratch or dust on the surface of the optical disc 7. The lip sync occurs not only due to the reproduction of the audio data going ahead of the reproduction of the visual data, but also the reproduction of the visual data going ahead of the reproduction of the audio data.

Since the response of visual perception of human is slower like the after image phenomenon, the visual perception cannot correspond to sudden variation of the brightness or quick change of the image. On the other hand, auditory perception of human is more sensitive than visual perception in comparison with each other. Thus, it is difficult to be noticed that the reproduction of the visual data is compensated so as to synchronize with the reproduction of the audio data rather than the reproduction of the audio data is compensated so as to synchronize with the reproduction of the visual data. Furthermore, the TV viewer tends to notice the occurrence of the lip sync when the reproduction of the audio data goes ahead of the reproduction of the visual data.

A capacity of the visual data for a predetermined period, however, is much larger than a capacity of the audio data for the same time period, so that it is necessary to increase a capacity of a memory of the visual data buffer 92 for memorizing the visual data of the predetermined period when the reproduction of the visual data is synchronized with the reproduction of the audio data. On the contrary, it is not necessary to increase a capacity of a memory of the audio buffer 93 so much for memorizing the audio data for the predetermined period when the reproduction of the audio data is synchronized with the reproduction of the visual data.

In this embodiment, when the reproduction of the visual data is not synchronized with the reproduction of the audio data, the reproduction of the audio data is paused or fast-forwarded for compensating the lip sync between the visual data and the audio data in a term during which no sound is outputted. Specifically, when the reproduction of the audio data goes ahead of the reproduction of the visual data, output of the audio data is stopped in a predetermined period equal to or shorter than a delay of the reproduction of the visual data from the reproduction of the audio data. Alternatively, when the reproduction of the audio data is delayed from the reproduction of the visual data, the output of the audio data is fast-forwarded by a predetermined period equal to or shorter than a delay of the reproduction of the audio data from the reproduction of the visual data.

In general, for example, when the operation mode of the optical disc apparatus 1 is switched from fast-forwarding mode to reproducing mode or from pausing mode to reproducing mode, no sound is outputted. The switching of the operation mode of the optical disc apparatus, however, is not operated frequently. Thus, the lip sync compensation process is executed in a term in the normal reproducing mode during which the TV viewer can hear no sound (audio mute mode), that is, the audio data are outputted but the level of the audio data is substantially equal to zero or less than a predetermined level at which the TV viewer can hear no sound.

The time information extractor 96 independently extracts the time information included in the visual data and the time information included in the audio data. When the reproduction of the audio data is synchronized with the reproduction of the visual data, the time information extracted from the audio data coincides with the time information extracted from the visual data. Alternatively, when the reproduction of the audio data is not synchronized with the reproduction of the visual data, the time information extracted from the audio data is a little different from the time information extracted from the visual data. Thus, the lip sync judger 97 compares the time information extracted from the audio data with the time information extracted from the visual data, judges whether the reproduction of the audio data goes ahead of or is delayed from the reproduction of the visual data, and calculates the delay between the reproduction of the audio data and the reproduction of the visual data. The lip sync judger 97 outputs a result of judgment and a data of the delay to the lip sync compensator 98.

The lip sync compensator 98 utilizes the predetermined term during which no sound is outputted, and controls the output or reproduction of the audio data corresponding to the result of judgment and data of the delay outputted from the lip sync judger 97. When the reproduction of the audio data goes ahead of the reproduction of the visual data, the lip sync compensator 98 stops the output of the audio data in the predetermined period. Alternatively, when the reproduction of the audio data is delayed from the reproduction of the visual data, the lip sync compensator 98 fast-forwards the output of the audio data of the predetermined period. More specifically, the lip sync compensator 98 controls the audio data buffer 93 in a manner so that the output of the audio data from the audio data buffer 93 to the audio data decoder 95 is stopped in the predetermined period, or the audio data of the predetermined period is discarded.

The predetermined periods with respect to the stopping the output of the audio data (pausing) and the fast-forwarding of the audio data (discarding) are essentially the periods equal to or shorter than the delay between the reproduction of the visual data and the reproduction of the audio data. When the reproduction of the audio data goes ahead of the reproduction of the visual data, the output of the audio data is stopped in the predetermined leading period of the audio data with respect to the visual data, and the output of the audio data is proceeded at a timing when the reproduction of the audio data is synchronized with the reproduction of the visual data. Alternatively, when the reproduction of the audio data is delayed from the reproduction of the visual data, the audio data corresponding to the delay are discarded.

If the lip sync compensation process (the AV synchronization process) owing to stopping the output of the audio data or discarding the audio data is executed during the normal reproduction mode, silent in the predetermined period or discontinuity of sound occurs, so that the TV viewer feels something is wrong. Thus, the lip sync compensation is executed in the term during which no sound is outputted, for example, when the operation mode of the optical disc apparatus is switched from the fast forwarding mode to the reproducing mode or from the pausing mode to the reproducing mode corresponding to the operation of the remote controller 11 by the TV viewer.

When the delay between the reproduction of the visual data and the reproduction of the audio data is longer than the term during which no sound is outputted, there is a possibility that the reproducing of the audio data cannot be synchronized with the reproduction of the visual data in one lip sync compensation process. In such the case, the lip sync compensation is repeated more than one so as to synchronize the reproducing of the audio data with the reproduction of the visual data. In the latter case, it is possible to select a period shorter than the delay between the visual data and the audio data for pausing or fast-forwarding the reproduction of the audio data in one lip sync compensation process.

Alternatively, when the delay between the visual data and the audio data is shorter than a predetermined period, there is no problem with no lip sync compensation, or there is a possibility that a relation of the delay between the visual data and the audio data is counterchanged as a result of the lip sync compensation. Thus, when the delay between the visual data and the audio data is shorter than a predetermined standard period such as 30 ms, the lip sync compensator 98 does not execute the lip sync compensation process from the beginning. Furthermore, when the delay between the visual data and the audio data becomes shorter than the predetermined standard period owing to the lip sync compensation, the lip sync compensator 98 completes the execution of the lip sync compensation process.

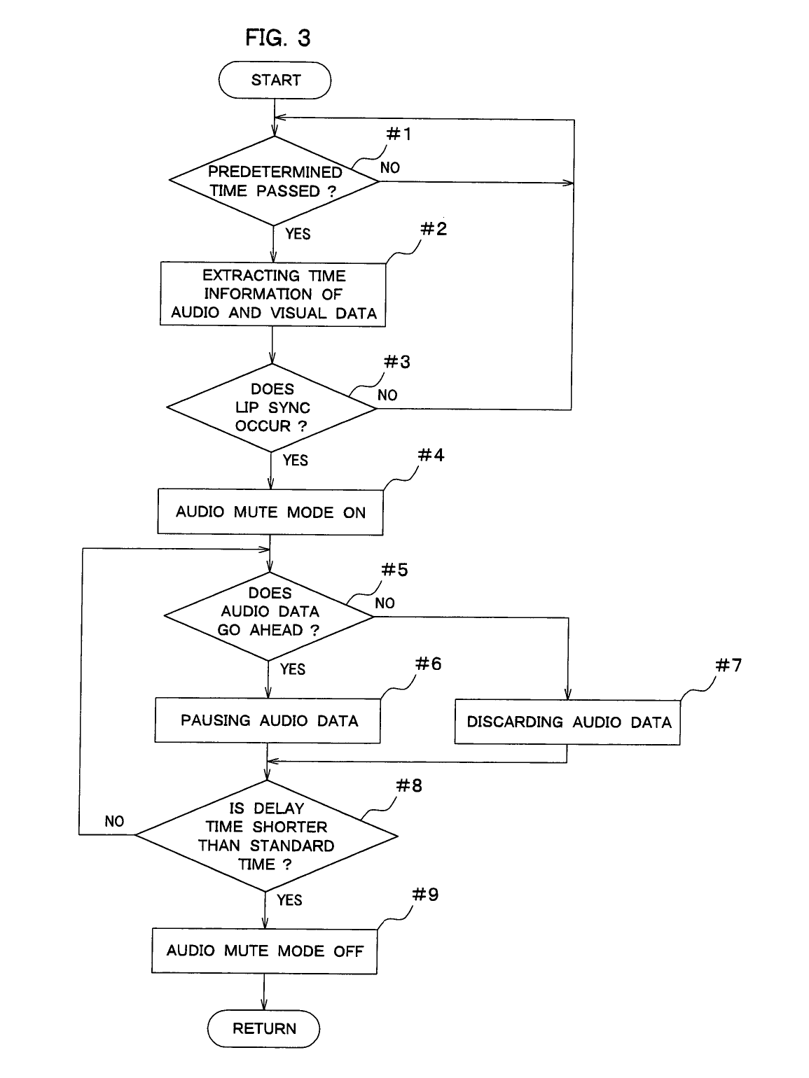

Subsequently, the lip sync compensation process is described with reference to a flowchart illustrated in FIG. 3. The flow illustrated in FIG. 3 is executed at a predetermined interval.

At the start, the lip sync judger 97 waits for passing a time corresponding to the above-mentioned predetermined interval (#1), and obtains time information of the visual data from the decoded visual data outputted from the visual data decoder 94 and time information of the audio data from the decoded audio data outputted from the audio data decoder 95 (#2). Subsequently, the lip sync judger 97 compares the time information of the visual data with the time information of the audio data, and judges whether a period of the lip sync equal to or larger than the predetermined period occurs between the visual data and the audio data or not (#3). When the reproduction of the visual data is synchronized with the reproduction of the audio data or when the period of the lip sync between the visual data and the audio data is shorter than the predetermined period, for example, 30 ms (“No” in the step #3), it is not necessary to compensate the lip sync. Thus, the lip sync compensator 98 does not execute the lip sync compensation process. The lip sync judger 97 returns to the step #1, and waits for passing the time corresponding to the predetermined interval so as to repeat the lip sync compensation.

When the lip sync having a period equal to or larger than the predetermined period occurs between the visual data and the audio data (“Yes” in the step #3), the lip sync judger 97 switches on the audio mute mode (#4) so as to wait a term (audio mute term) during which the level of the audio data is substantially equal to zero or less than the predetermined level at which the TV viewer can hear no sound. Subsequently, the lip sync judger 97 further judges whether the reproduction of the audio data goes ahead of the reproduction of the visual data or not (#5). When the reproduction of the audio data goes ahead of the reproduction of the visual data (“Yes” in the step #5), the lip sync judger 97 outputs a pausing signal to the lip sync compensator 98 for pausing the output of the audio data in the predetermined period. The lip sync compensator 98 waits for the audio mute term, and controls the audio data buffer 93 so as to stop the output of the audio data in the predetermined period (pausing) (#6). By such the pausing process, the leading of the audio data with respect to the visual data is shortened by the predetermined period, for example, 20 ms.

Alternatively, when the reproduction of the audio data is delayed from the reproduction of the visual data (“No” in the step #5), the lip sync judger 97 outputs a fast-forwarding signal to the lip sync compensator 98 for fast-forwarding the output of the audio data of the predetermined period. The lip sync compensator 98 waits for the audio mute term, and controls the audio data buffer 93 so as to discard the audio data of the predetermined period (#7). By such the fast-forwarding process, the delay of the audio data with respect to the visual data is shortened by the predetermined period.

Subsequently, the lip sync judger 97 judges whether the period of the lip sync between the visual data and the audio data after pausing the output of the audio data in the step #6 or discarding the audio data in the step #7 is equal to or shorter than the predetermined standard period, for example, 30 ms or not (#8). When the period of the lip sync between the visual data and the audio data after the lip sync compensation process becomes equal to or shorter than the predetermined standard period (“Yes” in the step #8), there is no need to compensate the lip sync, so that the lip sync judger 97 switches off the audio mute mode (#9), and the lip sync compensator 98 completes the lip sync compensation process. The lip sync judger 97 returns to the step #1, and waits for passing the time corresponding to the predetermined interval so as to repeat the next lip sync compensation. Alternatively, when the period of the lip sync between the visual data and the audio data after the lip sync compensation process is longer than the predetermined standard period (“No” in the step #8), the lip sync between the visual data and the audio data is not sufficiently compensated in one lip sync compensation process, so that the steps from #5 to #8 are repeated until the lip sync period becomes equal to or shorter than the predetermined standard period.

In the above-mentioned embodiment, the lip sync compensation process is executed in both cases that the reproduction of the audio data goes ahead of the reproduction of the visual data and that the reproduction of the audio data is delayed from the reproduction of the visual data. The present invention, however, is not restricted by the description of the embodiment. Since the auditory perception of human is more sensitive than the visual perception as mentioned above, even when the audio data are reproduced a little ahead of the visual data, the TV viewer can be amused by the moving picture without unpleasant sensation. Thus, it is possible to execute the lip sync compensation only when the reproduction of the audio data goes ahead of the reproduction of the visual data. Furthermore, when the leading of the reproduction of the audio data with respect to the reproduction of the visual data reaches to about 100 ms, discrepancy between the sound and the moving picture (lip sync) can obviously be noticed, so that the TV viewer feels something is wrong. Thus, it is possible to execute the lip sync compensation only when the leading of the reproduction of the audio data becomes equal to or larger than a predetermined standard period, for example, 100 ms.

In this embodiment, the output of the audio data is stopped or fast-forwarded by the predetermined period in the term during which no sound is outputted. Thus, the lip sync between the reproduction of the audio data and the reproduction of the visual data can be compensated without applying unpleasant feeling to the TV viewer. Furthermore, the audio data of the predetermined period are memorized in the audio data buffer (firmware) 93 while the output of the audio data are paused or fast-forwarded, so that the capacity of the buffer memory of the decoder chip is not necessarily increased. Since the lip sync compensation of the reproduction of the audio data with respect to the reproduction of the visual data can be processed by stopping the output of the audio data in the predetermined period or discarding the audio data of the predetermined period. No particular software for AV synchronization process is necessary.

In the above-mentioned audio mute mode in the steps #4 to #9, the lip sync compensator 98 waits for the audio mute term during which the level of the audio data is substantially equal to zero or less than the predetermined level at which the TV viewer can hear no sound. It, however, is possible forcibly to reduce the level of the audio data substantially equal to zero or less than the predetermined level for quickly compensating the lip sync.

This application is based on Japanese patent application 2002-261134 filed in Japan dated Sep. 6, 2002, the contents of which are hereby incorporated by references.

Although the present invention has been fully described by way of example with reference to the accompanying drawings, it is to be understood that various changes and modifications will be apparent to those skilled in the art. Therefore, unless otherwise such changes and modifications depart from the scope of the present invention, they should be construed as being included therein.

What is claimed is:

1. An optical disc apparatus using a decoder chip with no synchronization processing function of audio data and visual data comprising:
an optical pickup device for reading video data from on optical disc;
a separator for separating visual data and audio data from the video data;
a visual data decoder for decoding the separated visual data;
an audio data decoder for decoding the separated audio data;
a time information extractor independently for extracting time information of visual data from the visual data and for extracting time information of audio data from the audio data;
a lip sync judger for comparing the time information of the visual data with the time information of the audio data at a predetermined interval, and judges whether reproduction of the audio data is synchronized with reproduction of the visual data or not; and
a lip sync compensator for compensating lip sync between the audio data and the visual data by pausing or fast-forwarding the reproduction of the audio data in a predetermined period while no sound is outputted.

2. The optical disc apparatus in accordance with claim 1, wherein
the lip sync compensator controls the audio data buffer so as to stop output of the audio data in the predetermined period when the reproduction of the audio data goes ahead of the reproduction of the visual data.

3. The optical disc apparatus in accordance with claim 2, wherein
the predetermined period is equal to or shorter than a delay between the reproduction of the visual data and the reproduction of the audio data.

4. The optical disc apparatus in accordance with claim 2, wherein
the lip sync judger further judges whether the delay of the visual data with respect to the audio data is equal to or smaller than a predetermined standard period or not; and
the lip sync compensator completes the compensation of the lip sync between the audio data and the visual data when the delay of the visual data with respect to the audio data is equal to or smaller than the predetermined standard period.

5. The optical disc apparatus in accordance with claim 4, wherein
the predetermined standard period is a period in which occurrence of the lip sync between the audio data and the visual data is rarely noticed by a TV viewer.

6. The optical disc apparatus in accordance with claim 5, wherein
the predetermined standard period is 30 ms.

7. The optical disc apparatus in accordance with claim 1, wherein
the lip sync compensator controls the audio data buffer so as to discard the audio data of a predetermined period for fast-forwarding the reproduction of the audio data when the reproduction of the audio data is delayed from the reproduction of the visual data.

8. The optical disc apparatus in accordance with claim 7, wherein
the predetermined period is equal to or shorter than a delay between the reproduction of the audio data and the reproduction of the visual data.

9. The optical disc apparatus in accordance with claim 7, wherein
the lip sync judger further judges whether the delay of the audio data with respect to the visual data is equal to or smaller than a predetermined standard period or not; and
the lip sync compensator completes the compensation of the lip sync between the audio data and the visual data when the delay of the audio data with respect to the visual data is equal to or smaller than the predetermined standard period.

10. The optical disc apparatus in accordance with claim 9, wherein
the predetermined standard period is a period in which occurrence of the lip sync between the audio data and the visual data is rarely noticed by a TV viewer.

11. The optical disc apparatus in accordance with claim 10, wherein
the second predetermined period is 30 ms.

12. An optical disc apparatus using a decoder chip with no synchronization processing function of audio data and visual data comprising:
an optical pickup device for reading video data from on optical disc;
a separator for separating visual data and audio data from the video data;
a visual data decoder for decoding the separated visual data;
an audio data decoder for decoding the separated audio data;
a time information extractor independently for extracting time information of visual data from the visual data and for extracting time information of audio data from the audio data;
a lip sync judger for comparing the time information of the visual data with the time information of the audio data at a predetermined interval, and judges whether reproduction of the audio data is synchronized with reproduction of the visual data or not; and
a lip sync compensator for compensating lip sync between the audio data and the visual data by pausing the reproduction of the audio data in a predetermined period while no sound is outputted when the reproduction of the audio data goes ahead of the reproduction of the visual data more than a first predetermined standard period.

13. The optical disc apparatus in accordance with claim 12, wherein
the lip sync judger further judges whether the delay of the visual data with respect to the audio data is equal to or smaller than a second predetermined standard period or not; and
the lip sync compensator completes the compensation of the lip sync between the audio data and the visual data when the delay of the visual data with respect to the audio data is equal to or smaller than the second predetermined standard period.

14. The optical disc apparatus in accordance with claim 13, wherein
the first predetermined standard period is a period in which occurrence of the lip sync between the audio data and the visual data is obviously noticed by a TV viewer; and
the second predetermined standard period is a period in which occurrence of the lip sync between the audio data and the visual data is rarely noticed by the TV viewer.

15. The optical disc apparatus in accordance with claim 14, wherein
the first predetermined standard period is 100 ms and the predetermined standard period is 30 ms.
